(19) United States
(12) Patent Application Publication
(10) Pub. No.: US 2007/0132865 A1
(43) Pub. Date: Jun. 14, 2007

(54) Filtered noise reduction in digital images

(75) Inventors: James E. Adams JR., Rochester, NY (US); Andrew K. McMahon, Sunnyvale, CA (US); Pierre Della Nave, Sunnyvale, CA (US); Amy D. Enge, Spencerport, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/301,194

(22) Filed: Dec. 12, 2005

(51) Int. Cl. H04N 9/64

(52) U.S. Cl. 348/242

(57) ABSTRACT

A method of reducing noise in a digital image produced by a digital imaging device, includes producing a luminance and at least one chrominance channel from a full-color digital image with each channel having a plurality of pixels and each such pixel has a value; producing an edge value from neighboring pixels in neighborhoods in the at least one chrominance channel; modifying the pixel value in the chrominance channel with an infinite impulse response filter responsive to the edge value of the corresponding pixel neighborhood to provide a modified chrominance channel; and producing a full-color digital image from the luminance channel and the modified chrominance channel, with reduced noise.

### FIELD OF THE INVENTION

The invention relates generally to the field of digital image processing operations that are particularly suitable for use in all sorts of imaging devices.

### BACKGROUND OF THE INVENTION

Video cameras and digital still cameras generally employ noise reduction operations as a standard component of their image processing chains. When the levels of noise are low and the number of pixels in the image modest, most any established noise reduction technique will be sufficient. When the levels of noise are high or the number of pixels in the image is large enough to tax the available computational resources, then the proper choice and implementation of noise reduction algorithms becomes more critical. One general approach is to use infinite impulse response (IIR) filter technology because of its strong noise cleaning capabilities and minimal memory usage requirements, i.e., computations are done in place with generally small pixel neighborhoods. Due to the phase errors inherent in the use of IIR filters, it is not uncommon for the filters to be used adaptively in order to preserve edge detail and prevent “streaking” artifacts. There are examples in the prior art that describe this general approach. Most have to do with adaptive filtering of temporal signals (video sequences). In the case of filtering strictly spatial signals in a single still image U.S. Pat. No. 6,728,416 (Gallagher) teaches decomposing the luminance channel of an image into pedestal and texture signals with the use of an adaptive recursive filter. The adaptive recursive filter described is similar to a multistage adaptive infinite impulse response (IIR) filter. This has the effect of moving nearly all the noise in the original luminance channel into the texture signal. The relatively noise-free pedestal image can now be adjusted in contrast with little concern for noise amplification. The original texture signal is subsequently recombined with the contrast-enhanced pedestal image to produce a contrast-enhanced luminance channel with minimal noise amplification.

A significant problem with approaches based on noise reduction of the luminance information in the image is that strong noise reduction to address high noise levels generally requires significant degradation to the genuine image details.

### SUMMARY OF THE INVENTION

The present invention provides a method of reducing noise in a digital image produced by a digital imaging device, includes producing a luminance and at least one chrominance channel from a full-color digital image with each channel having a plurality of pixels and each such pixel has a value; producing an edge value from corresponding neighboring pixels in neighborhoods in the at least one chrominance channel; modifying the pixel value in the chrominance channel with an infinite impulse response filter responsive to the edge value of the corresponding pixel neighborhood to provide a modified chrominance channel; and producing a full-color digital image from the luminance channel and the modified chrominance channel, with reduced noise.

The invention uses IIR filters applied directly to the chrominance portions of a single digital still image to achieve strong noise reduction without degrading the luminance content of the image. A feature of the invention is that IIR filter can be adaptive. Additionally, IIR filters are particularly suitable to effect a direct spatial frequency decomposition of the luminance information of the image so that nonlinear noise reduction methods are used to more effectively reduce noise without degrading genuine scene details.

It is a feature of the present invention that a strong level of noise reduction can be achieved without degrading the genuine image details.

It is another feature of the present invention that computational requirements are reduced through the use of in-place computations, small pixel neighborhoods, and single-branch adaptive strategies.

### BRIEF DESCRIPTION OF THE DRAWINGS

FIG. 1 is a perspective of a computer system including a digital camera for implementing the present invention;

FIG. 2 is a block diagram of a preferred embodiment;

FIG. 3 is a more detailed block diagram of block 208 in FIG. 2;

FIG. 4 is a more detailed block diagram of block 300 in FIG. 3;

FIG. 5 is a more detailed block diagram of block 302 in FIG. 3;

FIG. 6 is a block diagram of an alternate embodiment;

FIG. 7 is a more detailed block diagram of block 214 in FIG. 6;

FIG. 8 is a block diagram of a different alternate embodiment;

FIG. 9 is a more detailed block diagram of block 218 in FIG. 8;

FIG. 10 is a block diagram of another different alternate embodiment; and

FIG. 11 is a corresponding pixel neighborhood employed during noise reduction.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, the computer program can be stored in a computer readable storage medium, which can comprise, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

Before describing the present invention, it facilitates understanding to note that the present invention is preferably utilized on any well-known computer system, such a personal computer. Consequently, the computer system will not be discussed in detail herein. It is also instructive to note that the images are either directly input into the computer system (for example by a digital camera) or digitized before input into the computer system (for example by scanning an original, such as a silver halide film).

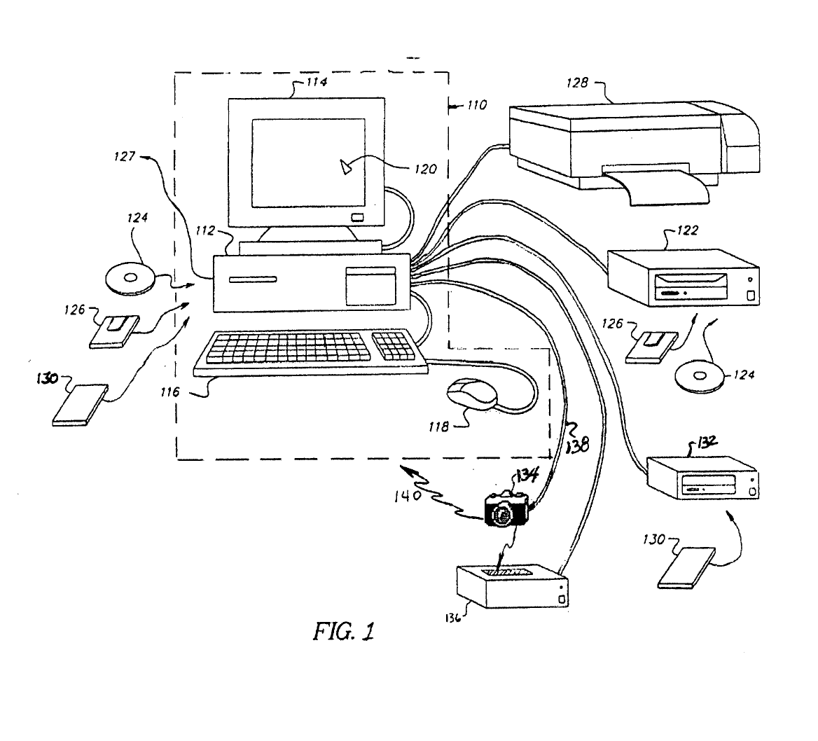

Referring to FIG. 1, there is illustrated a computer system 110 for implementing the present invention. Although the computer system 110 is shown for the purpose of illustrating a preferred embodiment, the present invention is not limited to the computer system 110 shown, but can be used on any electronic processing system such as found in home computers, kiosks, retail or wholesale photofinishing, or any other system for the processing of digital images. The computer system 110 includes a microprocessor-based unit 112 for receiving and processing software programs and for performing other processing functions. A display 114 is electrically connected to the microprocessor-based unit 112 for displaying user-related information associated with the software, e.g., by means of a graphical user interface. A keyboard 116 is also connected to the microprocessor based unit 112 for permitting a user to input information to the software. As an alternative to using the keyboard 116 for input, a mouse 118 can be used for moving a selector 120 on the display 114 and for selecting an item on which the selector 120 overlays, as is well known in the art.

A compact disk-read only memory (CD-ROM) 124, which typically includes software programs, is inserted into the microprocessor based unit for providing a means of inputting the software programs and other information to the microprocessor based unit 112. In addition, a floppy disk 126 can also include a software program, and is inserted into the microprocessor-based unit 112 for inputting the software program. The compact disk-read only memory (CD-ROM) 124 or the floppy disk 126 can alternatively be inserted into externally located disk drive unit 122 which is connected to the microprocessor-based unit 112. Still further, the microprocessor-based unit 112 can be programmed, as is well known in the art, for storing the software program internally. The microprocessor-based unit 112 can also have a network connection 127, such as a telephone line, to an external network, such as a local area network or the Internet. A printer 128 can also be connected to the microprocessor-based unit 112 for printing a hardcopy of the output from the computer system 110.

Images can also be displayed on the display 114 via a personal computer card (PC card) 130, such as, as it was formerly known, a PCMCIA card (based on the specifications of the Personal Computer Memory Card International Association), which contains digitized images electronically, embodied in the card 130. The PC card 130 is ultimately inserted into the microprocessor-based unit 112 for permitting visual display of the image on the display 114. Alternatively, the PC card 130 can be inserted into an externally located PC card readerl 32 connected to the microprocessor-based unit 112. Images can also be input via the compact disk 124, the floppy disk 126, or the network connection 127. Any images stored in the PC card 130, the floppy disk 126 or the compact disk 124, or input through the network connection 127, can have been obtained from a variety of sources, such as a digital camera (not shown) or a scanner (not shown). Images can also be input directly from a digital camera 134 via a camera docking port 136 connected to the microprocessor-based unit 112 or directly from the digital camera 134 via a cable connection 138 to the microprocessor-based unit 112 or via a wireless connection 140 to the microprocessor-based unit 112.

In accordance with the invention, the algorithm can be stored in any of the storage devices heretofore mentioned and applied to images in order to reduce noise in images.

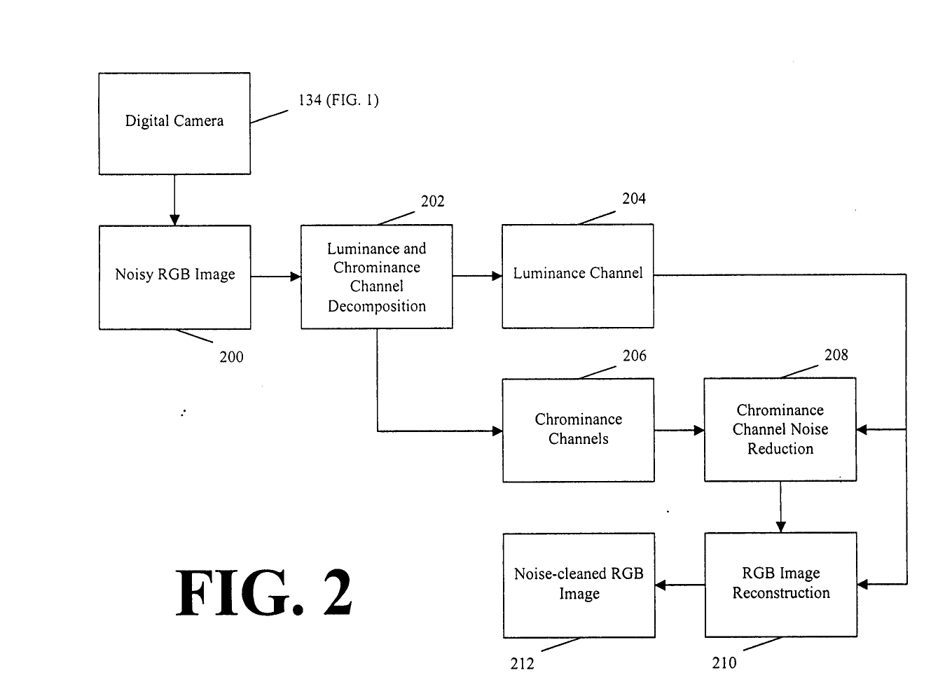

FIG. 2 is a high level diagram of the preferred embodiment. The digital camera 134 is responsible for creating an original red-green-blue (RGB) image that presumably contains noise (noisy RGB image) 200. This image is first decomposed into luminance and chrominance channels 202. In block 202 the following computations are performed in the preferred embodiment.

$$\{ \begin{matrix}Y = R + 2 G + B \\ {C}_{B} = 4 B - Y \\ {C}_{R} = 4 R - Y\end{matrix}$$

In this operation, for a given pixel location, R stands for the red value, G is the green value, and B is blue value. The corresponding luminance value, Y, and chrominance values, C_{B} and C_{R}, are computed from the RGB values. Alternate expressions for luminance and chrominance are equally useful such as the example below.

$$\{ \begin{matrix}Y = G \\ {C}_{B} = B \\ {C}_{R} = R\end{matrix}$$

It should be obvious to those skilled in the art that other transforms can be used. The luminance values together compose the luminance channel 204 and the chrominance values together compose the chrominance channels 206. The luminance and chrominance channels are then passed to the chrominance channel noise reduction operation 208 in which the noise in the chrominance channels is reduced. After block 208, the luminance and noise-reduced chrominance channels are converted back into RGB channels in the RGB image reconstruction step 210. In block 210 the following computations are performed.

$$\{ \begin{matrix}R = ( Y + {C}_{R} ) / 4 \\ B = ( Y + {C}_{B} ) / 4 \\ G = ( Y - R - B ) / 2\end{matrix}$$

The results of block 210 compose the noise-cleaned RGB image 212.

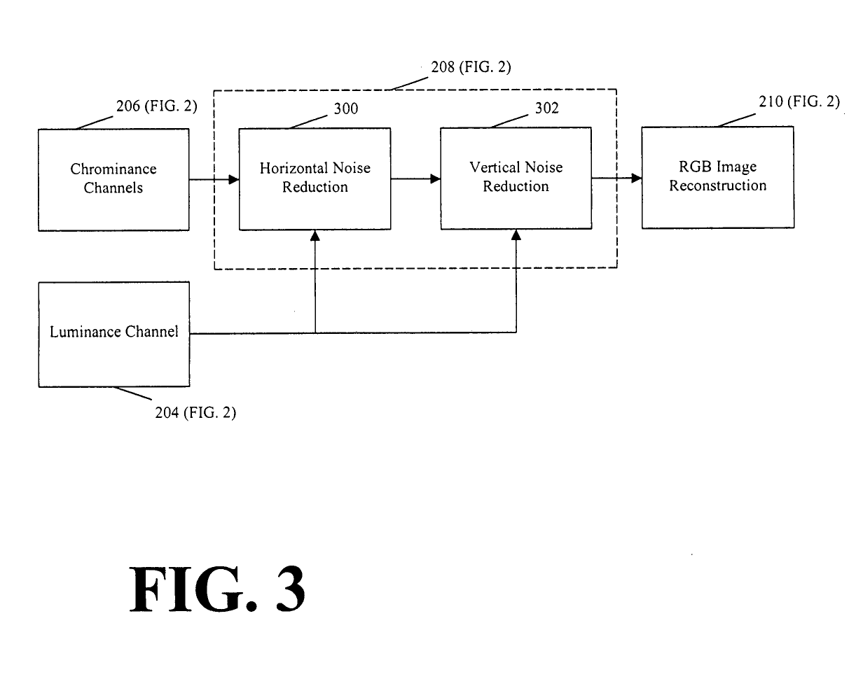

FIG. 3 is a more detailed diagram of the chrominance channel noise reduction 208 in FIG. 2. The chrominance channels 206 (FIG. 2) and the luminance channel 204 (FIG. 2) are passed to the horizontal noise reduction block 300. After the operations of block 300 are executed, the results along with the luminance channel 204 (FIG. 2) are passed to the vertical noise reduction block 302. The results of block 302 are then passed to the RGB image reconstruction block 210 (FIG. 2).

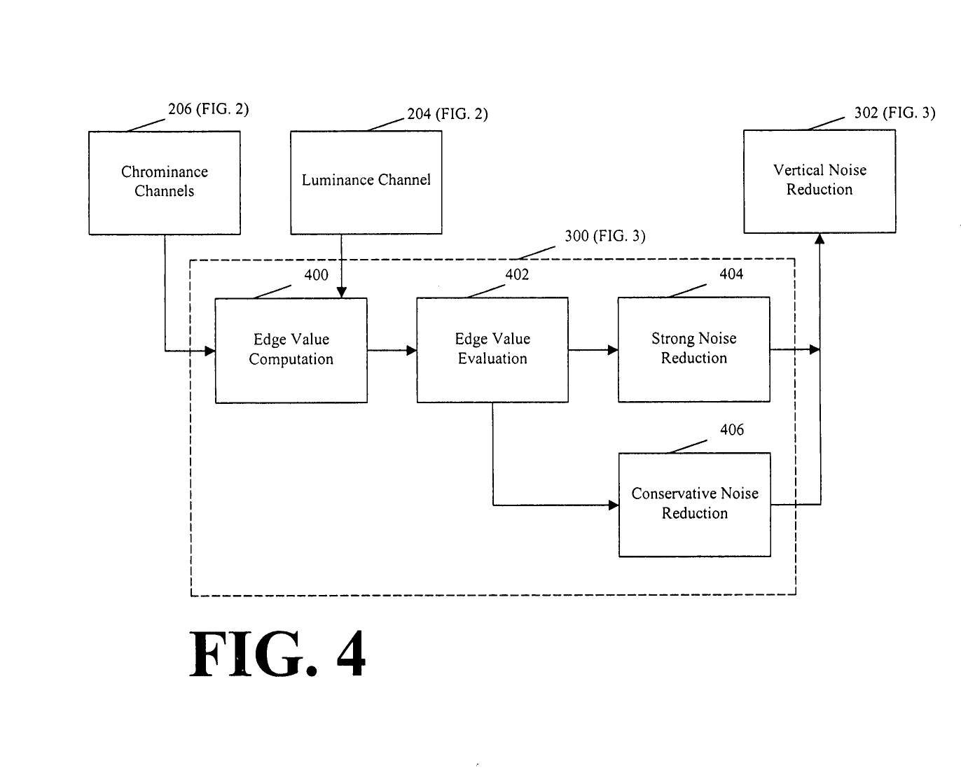

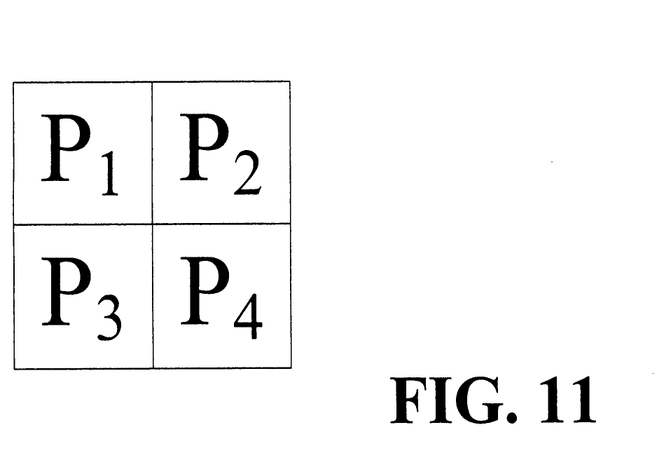

FIG. 4 is a more detailed diagram of the horizontal noise reduction 300 in FIG. 3. Processing the image from left to right, for each pixel location in the chrominance channel, an edge value is computed in edge value computation block 400. The corresponding pixel neighborhood employed by block 400 is diagrammed in FIG. 11. The edge value is computed for pixel location P₄. The edge value, E, is computed with the following expressions in the preferred embodiment.
E_{H}=|P₄(C_{B})−P₃(C_{B})|+|P₄(C_{R})−P₃(C_{R})|+4[P₄(Y)−P₃(Y)]₀^{∞}
E_{V}=|P₄(C_{B})−P₂(C_{B})|+|P₄(C_{R})−P₂(C_{R})|+4[P₄(Y)−P₂(Y)]₀^{∞}
E=E_{H}+E_{V}
In words, E_{H} is the sum of the C_{B} and C_{R} absolute gradients from P₄ to P₃ and four times the positive Y gradient from P₄ to P₃. (Negative Y gradients are clipped to zero for the purposes of this computation.) E_{V} is the sum of the C_{B} and C_{R} absolute gradients from P₄ to P₂ and four times the positive Y gradient from P₄ to P₂. The resulting edge value, E, is the sum of E_{H} and E_{V}. Alternate expressions for computing the edge value are also useful such as the example below.
E_{H}=|P₄(C_{B})−P₃(C_{B})|+|P₄(C_{R})−P₃(C_{R})|
E_{V}=|P₄(C_{B})−P₂(C_{B})|+|P₄(C_{R})−P₂(C_{R})|
E=E_{H}+E_{V}
It should be obvious to those skilled in the art that other variations such as luminance-only and single-chrominance-only expressions can be used. The edge value is then compared against a predetermined threshold value in the edge value evaluation block 402. This threshold value is used to partition the range of edge values into larger values (equal to or above the threshold value), which indicated the presence of an edge at P₄, and smaller values (less than the threshold value), which indicated the absence of an edge at P₄. In practice, the threshold value is determined through experimentation to strike a balance between noise reduction and edge preservation in the image. The edge value is used to select the appropriate impulse response filter. In the case of the edge value being equal to a larger value, a conservative noise reduction operation 406 is performed. Again referring to FIG. 11, the following expressions produce the noise-cleaned values for P₄.
P₄′(C_{B})=[P₄(C_{B})+P₃(C_{B})]/2
P₄′(C_{R})=[P₄(C_{R})+P₃(C_{R})]/2
The values of P₄(C_{B}) and P₄(C_{R}) in the image are immediately replaced with P₄′(C_{B}) and P₄′(C_{R}) as is customary with infinite impulse response filters. In the case of the edge value being a smaller value, a strong noise reduction operation 404 is performed. With reference to FIG. 11, the following expressions produce the noise-cleaned values for P₄.
P₄′(C_{B})=[P₄(C_{B})+7P₃(C_{B})]/8
P₄′(C_{R})=[P₄(C_{R})+7P₃(C_{R})]/8
The values of P₄(C_{B}) and P₄(C_{R}) in the image are immediately replaced with P₄′(C_{B}) and P₄′(C_{R}) as is customary with infinite impulse response filters. Once each pixel location is processed by block 300, the resulting chrominance channels are passed to the vertical noise reduction block 302 (FIG. 3).

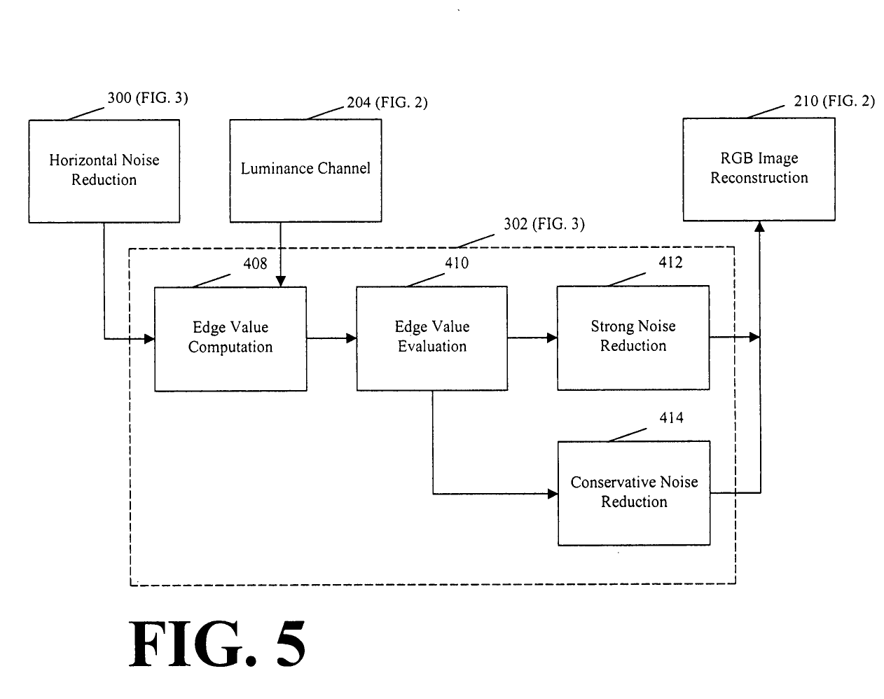

FIG. 5 is a more detailed diagram of the vertical noise reduction 302 in FIG. 3. Processing the image from top to bottom, for each pixel location in the chrominance channel, an edge value is computed in edge value computation block 408. The corresponding pixel neighborhood employed by block 408 is diagrammed in FIG. 11. The edge value is computed for pixel location P₄. The edge value, E, is computed with the following expressions.
E_{H}=|P₄(C_{B})−P₃(C_{B})|+|P₄ (C_{R})−P₃(C_{R})|+4[P₄(Y)−P₃(Y)]₀^{∞}
E_{V}=|P₄(C_{B})−P₂(C_{B})|+|P₄(C_{R})−P₂(C_{R})|+4[P₄(Y)−P₂(Y)]₀^{∞}
E=E_{H}+E_{V}
In words, E_{H} is the sum of the C_{B} and C_{R} absolute gradients from P₄ to P₃ and four times the positive Y gradient from P₄ to P₃. (Negative Y gradients are clipped to zero for the purposes of this computation.) E_{V} is the sum of the C_{B} and C_{R} absolute gradients from P₄ to P₂ and four times the positive Y gradient from P₄ to P₂. The resulting edge value, E, is the sum of E_{H} and E_{V}. Alternate expressions for computing the edge value are also useful such as the example below.
E_{H}=|P₄(C_{B})−P₃(C_{B)|+|}P₄(C_{R})−P₃(C_{R})|
E_{V}=|P₄(C_{B})−P₂(C_{B)|+|}P₄(C_{R})−P₂(C_{R})|
E=E_{H}+E_{V}
It should be obvious to those skilled in the art that other variations such as luminance-only and single-chrominance-only expressions can be used. The edge value is then compared against a predetermined threshold value in the edge value evaluation block 410. This threshold value is used to partition the range of edge values into larger values (equal to or above the threshold value), which indicated the presence of an edge at P₄, and smaller values (less than the threshold value), which indicate the absence of an edge at P₄. In practice, the threshold value is determined through experimentation to strike a balance between noise reduction and edge preservation in the image. The edge value is used to select the appropriate impulse response filter. In the case of the edge value being equal a to larger value, a conservative noise reduction operation 414 is performed. Again referring to FIG. 11, the following expressions produce the noise-cleaned values for P₄.
P₄′(C_{B})=[P₄(C_{B})+P₂(C_{B})]/2
P₄′(C_{R})=[P₄(C_{R})+P₂(C_{R})]/2
The values of P₄(C_{B}) and P₄(C_{R}) in the image are immediately replaced with P₄′(C_{B}) and P₄′(C_{R}) as is customary with infinite impulse response filters. In the case of the edge value being a smaller value, a strong noise reduction operation 412 is performed. With reference to FIG. 11, the following expressions produce the noise-cleaned values for P₄.
P₄′(C_{B})=[P₄(C_{B})+7P₂(C_{B})]/8
P₄′(C_{R})=[P₄(C_{R})+7P₂(C_{R})]/8
The values of P₄(C_{B}) and P₄(C_{R}) in the image are immediately replaced with P₄′(C_{B}) and P₄′(C_{R}) as is customary with infinite impulse response filters. Once each pixel location is processed by block 302, the resulting chrominance channels are passed to the RGB image reconstruction block 210 (FIG. 2).

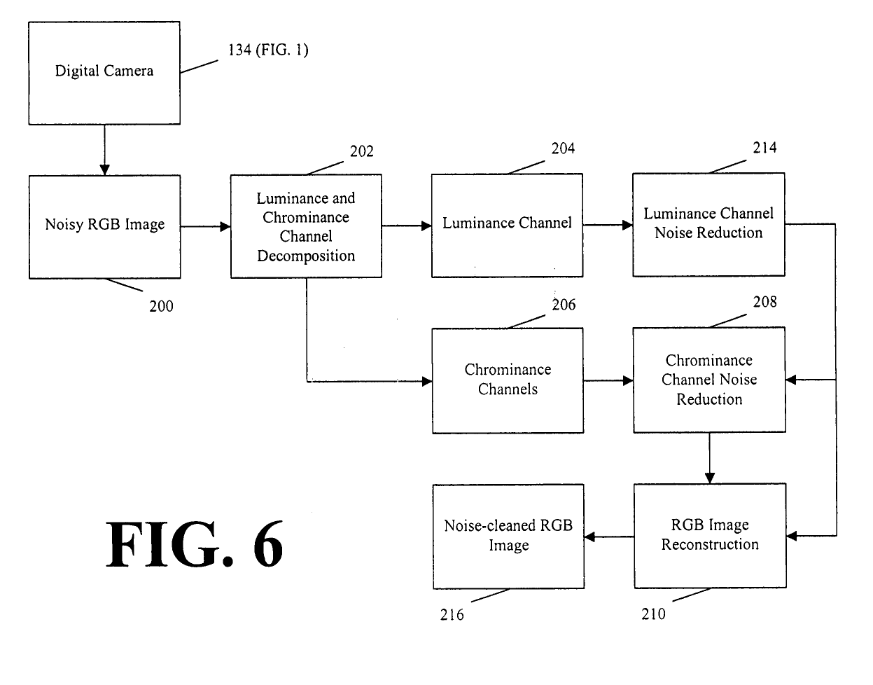

FIG. 6 is a high level diagram of an alternate embodiment. The digital camera 134 is responsible for creating an original red-green-blue (RGB) image that presumably contains noise (noisy RGB image) 200. This image is first decomposed into luminance and chrominance channels 202 as previously described. The luminance values together compose the luminance channel 204 and the chrominance values together compose the chrominance channels 206. The luminance channel is passed to the luminance channel noise reduction block 214 in which the noise in the luminance channel is reduced. The noise-reduced luminance and (original) chrominance channels are then passed to the chrominance channel noise reduction operation 208 in which the noise in the chrominance channels is reduced as previously described. After block 208, the noise-reduced luminance and noise-reduced chrominance channels are converted back into RGB channels in the RGB image reconstruction step 210 as previously described. The results of block 210 compose the noise-cleaned RGB image for this embodiment 216.

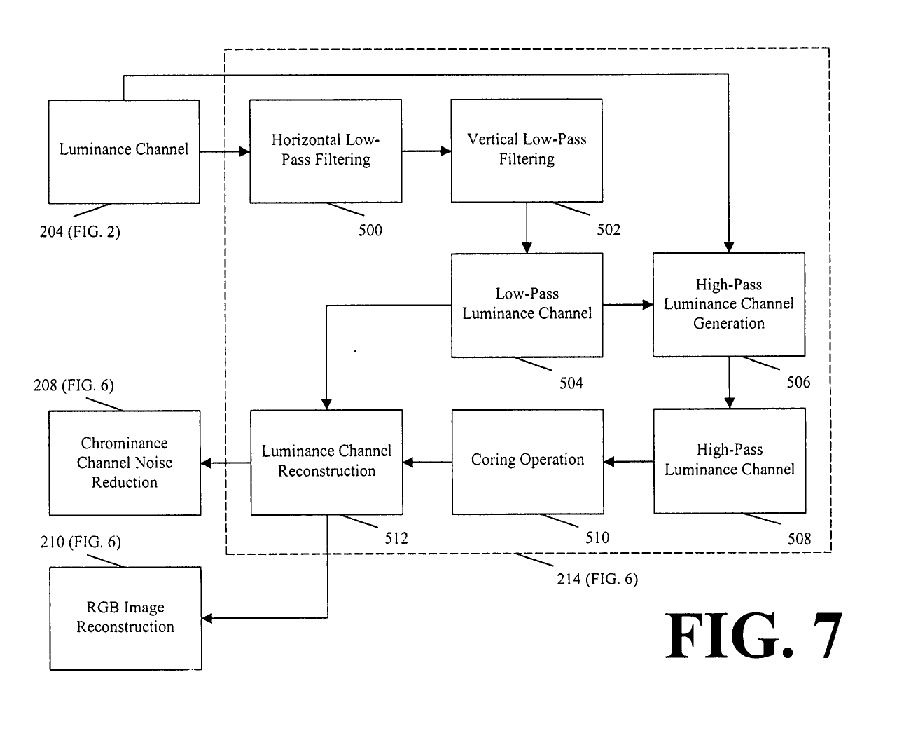

FIG. 7 is a more detailed diagram of the luminance noise reduction block 214 in FIG. 6. A copy of the luminance channel 204 (FIG. 2) is passed to the horizontal low-pass filtering block 500. Referring to FIG. 11, the computation performed by block 500 is expressed below.
P₄′(Y)=[P₄(Y)+P₃(Y)]/2
The value of P₄(Y) in the image is immediately replaced with P₄′(Y) as is customary with infinite impulse response filters. The results of block 500 are passed to the vertical low-pass filtering block 502 to produce a low-pass luminance channel 504. Again referring to FIG. 11, the computation performed by block 502 is expressed below.
P₄′(Y)=[P₄(Y)+P₂(Y)]/2
The value of P₄(Y) in the image is immediately replaced with P₄′(Y) as is customary with infinite impulse response filters. The original luminance channel 204 (FIG. 2) is combined with the low-pass luminance channel 504 by the high-pass luminance channel generation block 506. Block 506 performs this combination by subtracting the low-pass luminance channel 504 from the luminance channel 204 (FIG. 2). The result of block 506 is a high-pass luminance channel 508. A coring operation 510 is next performed on the high-pass luminance channel 508. For each pixel value, X, in the high-pass luminance channel 508, the value is compared to a threshold value T and the corresponding cored pixel value, Y, is computed with the following expression.

$$Y = \{ \begin{matrix}X + T , & X < - T \\ 0 , & - T \leq X \leq T \\ X - T , & T < X\end{matrix}$$

The threshold value, T, is determined experimentally to balance the amount of noise reduction and edge detail preservation in the image. The results of block 510 along with the low-pass luminance channel 504 are sent to the luminance channel reconstruction block 512. Block 512 performs this reconstruction by adding the low-pass luminance channel 504 with the results of the coring operation 510. The result of block 512 is sent to the chrominance channel noise reduction block 208 (FIG. 6) and the RGB image reconstruction block 210 (FIG. 6).

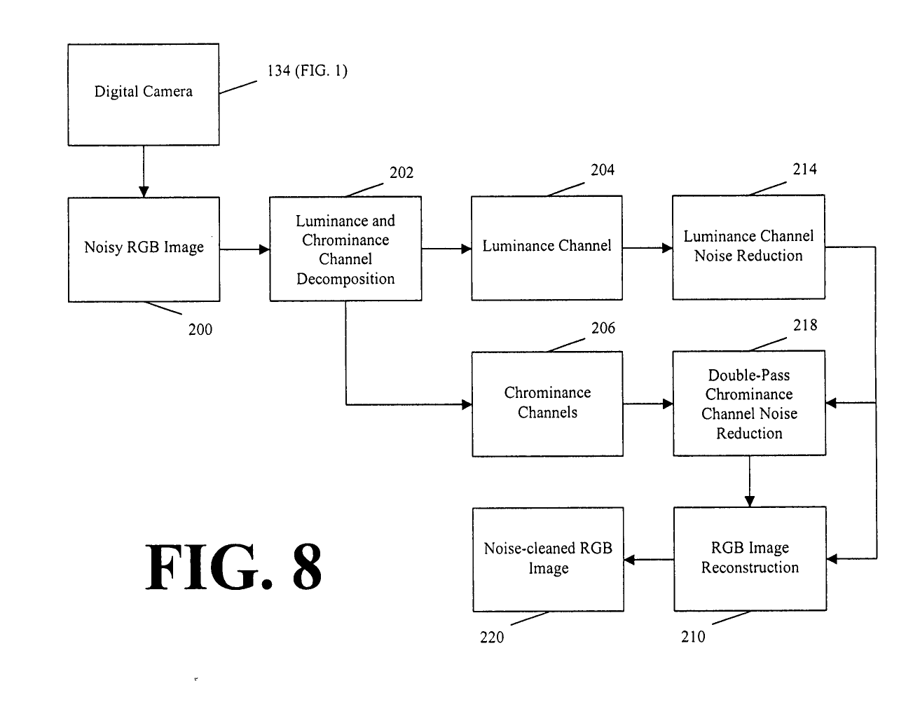

FIG. 8 is a high level diagram of an alternate embodiment. The. digital camera 134 is responsible for creating an original red-green-blue (RGB) image that presumably contains noise (noisy RGB image) 200. This image is first decomposed into luminance and chrominance channels 202 as previously described. The luminance values together compose the luminance channel 204 and the chrominance values together compose the chrominance channels 206. The luminance channel is passed to the luminance channel noise reduction block 214 in which the noise in the luminance channel is reduced as previously described. The noise-reduced luminance and (original) chrominance channels are then passed to the double-pass chrominance channel noise reduction operation 218 in which the noise in the chrominance channels is reduced. After block 218, the noise-reduced luminance and noise-reduced chrominance channels are converted back into RGB channels in the RGB image reconstruction step 210 as previously described. The results of block 210 compose the noise-cleaned RGB image for this embodiment 220.

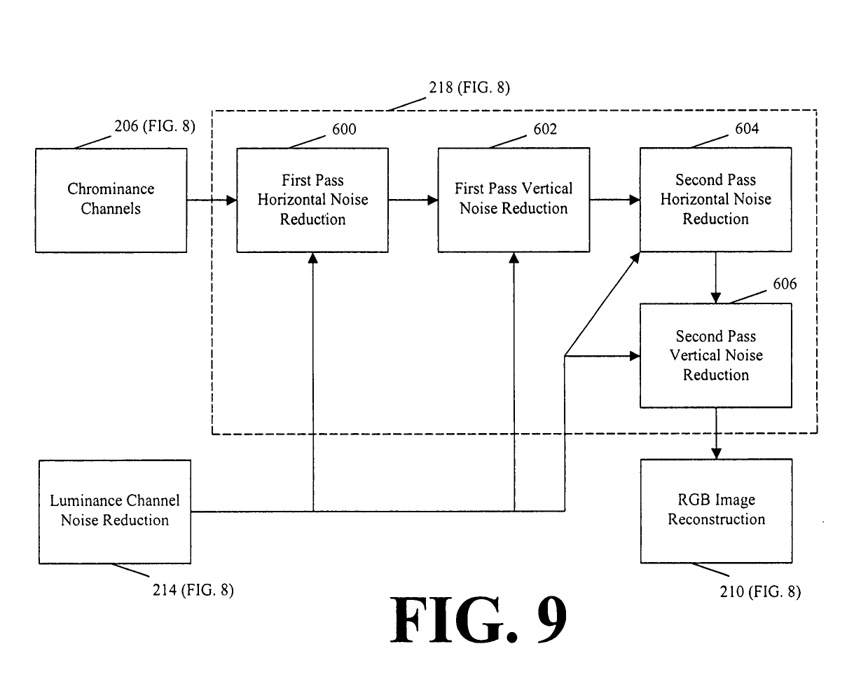

FIG. 9 is a more detailed diagram of the double-pass chrominance channel noise reduction block 218 in FIG. 8. The chrominance channels 206 (FIG. 8) and the results of the luminance channel noise reduction block 214 (FIG. 8) are passed to the first pass horizontal noise reduction block 600. The details of block 600 are identical to the details of previously described horizontal noise reduction block 300 (FIG. 3). The results of the first pass horizontal noise reduction block 600 and the results of the luminance channel noise reduction block 214 (FIG. 8) are passed to the first pass vertical noise reduction block 602. The details of block 602 are identical to the details of previously described vertical noise reduction block 302 (FIG. 3). The results of the first pass vertical noise reduction block 600 and the results of the luminance channel noise reduction block 214 (FIG. 8) are passed to the second pass horizontal noise reduction block 604. The details of block 604 are similar to the details of previously described horizontal noise reduction block 600 with the following exceptions. The image is processed from right to left in block 604. Referring to FIG. 11, the edge value computation for P₁ is described by the following expressions.
E_{H}=|P₁(C_{B})−P₂(C_{B})|+|P₁(C_{R})−P₂(C_{R})|+4[P₁(Y)−P₂(Y)]₀^{∞}
E_{V}=|P₁(C_{B})−P₃(C_{B})|+|P₁(C_{R})−P₃(C_{R})|4[P₁(Y)−P₃(Y)]₀^{∞}
E=E_{H}+E_{V}
The conservative noise reduction for P₁ is accomplished with the following expressions.
P₁′(C_{B})=[P₁(C_{B})+P₂(C_{B})]/2
P₁′(C_{R})=[P₁(C_{R})+P₂(C_{R})]/2
The strong noise reduction for P₁ is accomplished with the following expressions.
P₁′(C_{B})=[P₁(C_{B})+7P₂(C_{B})]/8
P₁′(C_{R})=[P₁(C_{R})+7P₂(C_{R})]/8
A smaller threshold value is generally used in block 604 than in block 600. (In general, the threshold value in block 604 is half as large as the threshold value in block 600.) The results of the second pass horizontal noise reduction block 604 and the results of the luminance channel noise reduction block 214 (FIG. 8) are passed to the second pass vertical noise reduction block 606. The details of block 606 are similar to the details of previously described vertical noise reduction block 602 with the following exceptions. The image is processed from bottom to top in block 606. Referring to FIG. 11, the edge value computation for P₁ is described by the following expressions.
E_{H}=|P₁(C_{B})−P₂(C_{B})|+|P₁(C_{R})−P₂(C_{R})|+4[P₁(Y)−P₂(Y)]₀^{∞}
E_{V}=|P₁(C_{B})−P₃(C_{B})|+|P₁(C_{R})−P₃(C_{R})|+4[P₁(Y)−P₃(Y)]₀^{∞}
E=E_{H}+E_{V}
The conservative noise reduction for P₁ is accomplished with the following expressions.
P₁′(C_{B})=[P₁(C_{B})+P₃(C_{B})]/2
P₁′(C_{R})=[P₁(C_{R})+P₃(C_{R})]/2
The strong noise reduction for P₁ is accomplished with the following expressions.
P₁′(C_{B})=[P₁(C_{B})+7P₃(C_{B})]/8
P₁′(C_{R})=[P₁(C_{R})+7P₃(C_{R})]/8
A smaller threshold value is generally used in block 606 than in block 602. (In general, the threshold value in block 606 is half as large as the threshold value in block 602.) The results of block 606 are then passed to the RGB image reconstruction block 210 (FIG. 2).

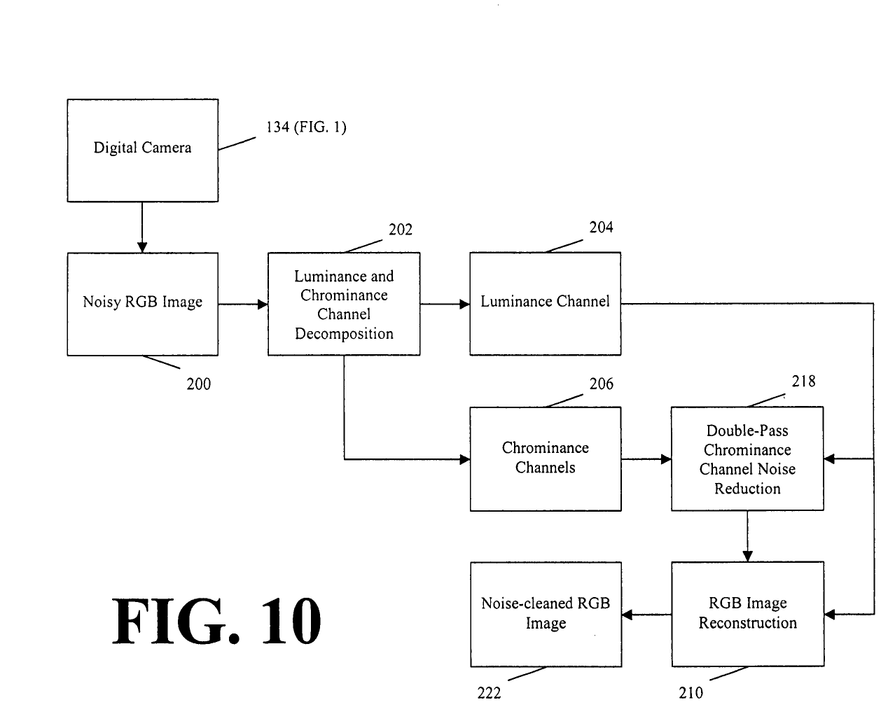

FIG. 10 is a high level diagram of an alternate embodiment. The digital camera 134 is responsible for creating an original red-green-blue (RGB) image that presumably contains noise (noisy RGB image) 200. This image is first decomposed into luminance and chrominance channels 202 as previously described. The luminance values together compose the luminance channel 204 and the chrominance values together compose the chrominance channels 206. The luminance and chrominance channels are then passed to the double-pass chrominance channel noise reduction operation 218 in which the noise in the chrominance channels is reduced. After block 218, the noise-reduced luminance and noise-reduced chrominance channels are converted back into RGB channels in the RGB image reconstruction step 210 as previously described. The results of block 210 compose the noise-cleaned RGB image for this embodiment 222.

The noise reduction algorithm disclosed in the preferred embodiment(s) of the present invention can be employed in a variety of user contexts and environments. Exemplary contexts and environments include, without limitation, wholesale digital photofinishing (which involves exemplary process steps or stages such as film in, digital processing, prints out), retail digital photofinishing (film in, digital processing, prints out), home printing (home scanned film or digital images, digital processing, prints out), desktop software (software that applies algorithms to digital prints to make them better—or even just to change them), digital fulfillment (digital images in—from media or over the web, digital processing, with images out—in digital form on media, digital form over the web, or printed on hard-copy prints), kiosks (digital or scanned input, digital processing, digital or scanned output), mobile devices (e.g., PDA or cell phone that can be used as a processing unit, a display unit, or a unit to give processing instructions), and as a service offered via the World Wide Web.

In each case, the noise reduction algorithm can stand alone or can be a component of a larger system solution. Furthermore, the interfaces with the algorithm, e.g., the scanning or input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the algorithm itself can be fully automatic, can have user input (be fully or partially manual), can have user or operator review to accept/reject the result, or can be assisted by metadata (metadata that can be user supplied, supplied by a measuring device (e.g. in a camera), or determined by an algorithm). Moreover, the algorithm can interface with a variety of workflow user interface schemes.

The noise reduction algorithm disclosed herein in accordance with the invention can have interior components that utilize various data detection and reduction techniques (e.g., face detection, eye detection, skin detection, flash detection)

The invention has been described in detail with particular reference to certain preferred embodiments thereof, but it will be understood that variations and modifications can be effected within the spirit and scope of the invention.

### Parts List

110 Computer System
112 Microprocessor-based Unit
114 Display
116 Keyboard
118 Mouse
120 Selector on Display
122 Disk Drive Unit
124 Compact Disk—read Only Memory (CD-ROM)
126 Floppy Disk
127 Network Connection
128 Printer
130 Personal Computer Card (PC card)
132 PC Card Reader
134 Digital Camera
136 Camera Docking Port
138 Cable Connection
140 Wireless Connection
200 Noisy RGB Image
202 Luminance and Chrominance Channel Decomposition
204 Luminance Channel
206 Chrominance Channels
208 Chrominance Channel Noise Reduction
210 RGB Image Reconstruction
212 Noise-cleaned RGB Image
214 Luminance Channel Noise Reduction
216 Noise-cleaned RGB Image
218 Double-Pass Chrominance Channel Noise Reduction
220 Noise-cleaned RGB Image
222 Noise-cleaned RGB Image
300 Horizontal Noise Reduction
302 Vertical Noise Reduction
400 Edge Value Computation
402 Edge Value Evaluation
404 Strong Noise Reduction
406 Conservative Noise Reduction
408 Edge Value Computation
410 Edge Value Evaluation
412 Strong Noise Reduction
414 Conservative Noise Reduction
500 Horizontal Low-Pass Filtering
502 Vertical Low-Pass Filtering
504 Low-Pass Luminance Channel
506 High-Pass Luminance Channel Generation
508 High-Pass Luminance Channel
510 Coring Operation
512 Luminance Channel Reconstruction
600 First Pass Horizontal Noise Reduction
602 First Pass Vertical Noise Reduction
604 Second Pass Horizontal Noise Reduction
606 Second Pass Vertical Noise Reduction

What is claimed is:

1. A method of reducing noise in a digital image produced by a digital imaging device, comprising:
(a) producing a luminance and at least one chrominance channel from a full-color digital image with each channel having a plurality of pixels and each such pixel has a value;
(b) producing an edge value from neighboring pixels in neighborhoods in the at least one chrominance channel;
(c) modifying the pixel value in the chrominance channel with an infinite impulse response filter responsive to the edge value of the corresponding pixel neighborhood to provide a modified chrominance channel; and
(d) producing a full-color digital image from the luminance channel and the modified chrominance channel, with reduced noise.

2. The method of claim 1 further including selecting an infinite impulse response filter based upon edge values.

3. The method of claim 1 wherein the infinite impulse response filter uses from the neighborhood of a given pixel the combination of two neighborhood pixel values.

4. A method of reducing noise in a digital image produced by a digital imaging device, comprising:
(a) producing a luminance and at least one chrominance channel from a full-color digital image with each channel having a plurality of pixels and each such pixel has a pixel value;
(b) producing a low-pass luminance channel and a high-pass luminance channel from the luminance channel;
(c) modifying each pixel value in the high-pass luminance channel responsive to its initial pixel value;
(d) producing a modified luminance channel from the low-pass luminance channel and the modified high-pass luminance channel;
(e) producing an edge value from neighboring pixels in neighborhoods in the at least one chrominance channel;
(f) modifying each pixel value in each chrominance channel with an infinite impulse response filter responsive to the edge value of the corresponding pixel neighborhood to provide a modified chrominance channel; and
(g) producing a full-color digital image from the modified luminance channel and the modified chrominance channel, with reduced noise.

5. The method of claim 4 using a coring operation to produce the modified high-pass luminance channel pixel values.

6. The method of claim 4 further including selecting an infinite impulse response filter based upon edge values.

7. The method of claim 4 wherein the infinite impulse response filter uses from the neighborhood of a given pixel, the combination of two neighborhood pixel values.
